(19) United States
(12) Patent Application Publication
(10) Pub. No.: US 2012/0243622 A1
(43) Pub. Date: Sep. 27, 2012

(54) METHOD AND APPARATUS FOR IMPROVING THE ERROR RATE OF A SERIAL/DE-SERIAL BACKPLANE CONNECTION

(75) Inventors: Ofer Iny, Tel Aviv (IL); Uri Amit, Tel Aviv (IL); Itzhak Kiselevsky, Kfar Saba (IL)

(73) Assignee: Broadcom Corporation, Irvine, CA (US)

(21) Appl. No.: 13/069,957

(22) Filed: Mar. 23, 2011

(51) Int. Cl. H04L 27/00

(52) U.S. Cl. 375/259

(57) ABSTRACT

Methods and apparatus that reduce the error rate of a Serial-De-Serial (SerDes) backplane connection are shown. The apparatus may include a receiver verifying a received block of data at the PHY layer. When the received block of data is received correctly, that block can be acknowledged by the receiver to the transmitter, which is also located at the PHY later. Upon detection of an error in a block of data, the receiver may send a negative acknowledge along with the block number, or some other suitable block identifier, of the faulty block to the transmitter. The transmitter may buffer blocks of data, and remove each block from the buffer upon receiving an acknowledgement. Use of the retransmission protocol may be triggered by speed of the connection, the bandwidth of the connection, the detection of too many errors in the connection or any suitable combination of these, or other, parameters.

### FIELD OF TECHNOLOGY

Aspects of the disclosure relate to providing methods and apparatus for reducing the error rate of a Serial-De-Serial (SerDes) backplane connection.

### BACKGROUND OF THE INVENTION

Backplane connections may be arranged as point-to-point connections. Backplane connections may also be arranged as a serial or a parallel bus. One example implementation of a high speed bus may utilize SerDes connections. Typically bits on a backplane are transmitted without the use of error correction. In certain circumstances, even a relatively minimal retransmission protocol may be sufficient when the speed and bandwidth of the connection is relatively low.

Increasingly, high data rate on backplanes are required for certain applications. However, the error rate of a typical high speed (>10 Gigabits/second) SerDes connection is limited to a Bit Error Rate (BER) of about 10⁻¹²-10⁻¹⁵. This error rate may be unacceptable.

When a typical network connection has an unacceptable BER it is typically improved to an acceptable level by an error control method. Ordinarily error correction takes place at the Data Link or Logical Link Control (LLC) network layer. However, a backplane connection may be constrained due to performance and cost requirements to implementing error correction at a low overhead physical layer (PHY layer).

A typical method of error correction employed by networks is Forward Error Correction (FEC). However FEC may be unsuitable due to the limited performance of FEC as well as the significant complexity and bandwidth consumption of a backplane connection. Correcting errors at a higher network layer is unsuitable due to performance and cost constraints.

Therefore it would be desirable to provide a low overhead, efficient error correction mechanism that is suitable for a high speed SerDes backplane connection.

### SUMMARY OF THE INVENTION

A semiconductor device or system, substantially as shown in and/or described in connection with at least one of the figures, as set forth more completely in the claims. The device may include mechanisms that improve the BER of a SerDes backplane connection.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 shows a system comprised of a backplane and several cards;

FIG. 2 shows an example of a transmit architecture for a SerDes connection;

FIG. 3 shows an example of a receive architecture for a SerDes connection;

FIG. 4 shows an example of a data block for a SerDes connection;

FIG. 5 shows an example of Backwards Error Correction information;

FIG. 6 shows an example of a transmit data algorithm;

FIG. 7 shows an example of a replay buffer management algorithm;

FIG. 8 shows an example of a re-transmit data algorithm; and

FIG. 9 shows an example of a receive data algorithm.

### DETAILED DESCRIPTION OF THE DISCLOSURE

Apparatus and methods for improving the BER of a SerDes backplane connection are provided. It should be noted that the methods and apparatus of the present invention apply not only to backplanes, but also to any suitable serial data links with any suitable media type—e.g., copper cable, optic fiber, etc. It should be further noted that the methods and apparatus of the present invention may be understood to apply to any chip to chip connection and/or module to module connection whether or not the chips and/or the modules are connected to a backplane. The methods and apparatus of the present invention have only been described in the context of a backplane for the sake of clarity of disclosure.

Illustrative embodiments of apparatus and methods in accordance with the principles of the invention will now be described with reference to the accompanying drawings, which form a part hereof. It is to be understood that other embodiments may be utilized and structural, functional and procedural modifications may be made without departing from the scope and spirit of the present invention.

As will be appreciated by one of skill in the art, the invention described herein may be embodied in whole or in part as a method, a data processing system, or a computer program product. Accordingly, the invention may take the form of an entirely hardware embodiment, an entirely software/firmware embodiment or an embodiment combining software, firmware, hardware and any other suitable approach or apparatus.

Furthermore, such aspects may take the form of a computer program product stored by one or more computer-readable storage media having computer-readable program code, or instructions, embodied in or on the storage media. Any suitable computer readable storage media may be utilized, including hard disks, EEPROM, Flash memory, SRAM, DRAM, CD-ROMs, optical storage devices, magnetic storage devices, and/or any combination thereof. In addition, various signals representing data or events as described herein may be transferred between a source and a destination in the form of electromagnetic waves traveling through signal-conducting media such as metal wires, optical fibers, and/or wireless transmission media—e.g., air and/or space.

It is desirable for a high speed backplane connection to be both reliable and inexpensive. A solution according to the invention may augment a backplane connection with retransmission protocol, without substantially increasing the cost of such a connection. The augmentation may include enabling the receiver of a faulty block, a faulty block of packets, and/or a faulty block of idle data, with the ability to contact the transmitter of the faulty block. Likewise, the faulty block may be identified by the receiver to the transmitter in order to enable retransmission of the faulty packet. For the purposes of this application, any reference to a faulty block and/or a faulty packet can be understood to apply to either one or both of the faulty block and/or a faulty block of idle data, or any other faulty block and/or faulty packet.

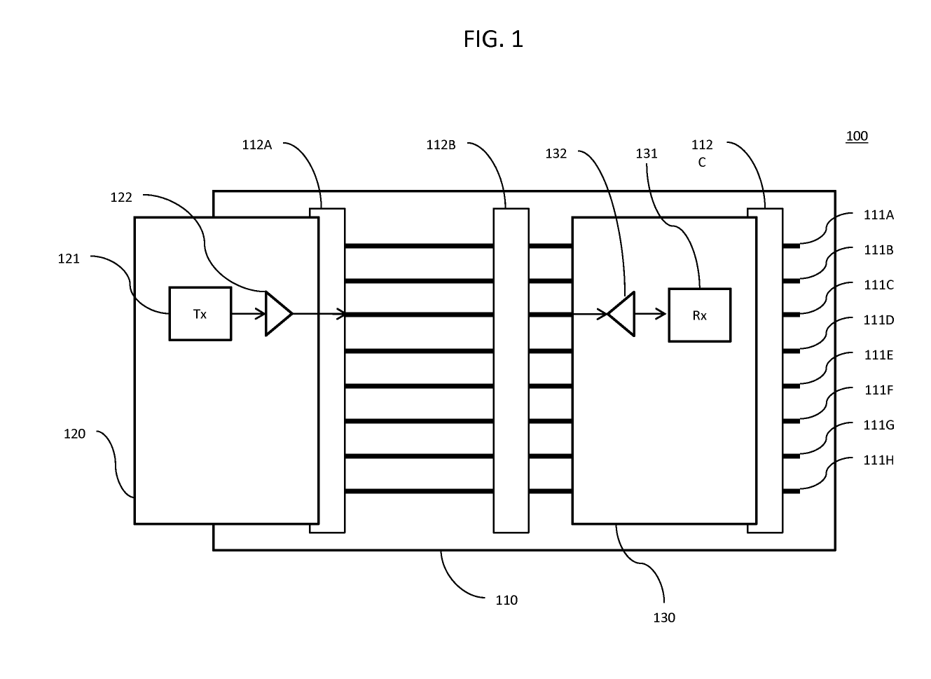

An example configuration of a backplane based system 100 is shown in FIG. 1. System 100 may be comprised of a backplane 110 and cards 120 and 130. Backplane 110 comprises traces 111A-111H and connectors 112A, 112B and 112C. Backplane 110 may be active or passive.

Connector 112A connects card 120 to backplane 110. Connector 112B is unused in the example configuration of system 100. Connector 112C connects card 130 to backplane 110.

Card 120 shows a transmitter 121 connected to serializer 122 which drives trace 111C. In some embodiments the serializer 122 is included within the transmitter 121. Card 130 shows a de-serializer 132 which receives bits from trace 111C. De-serializer 132 provides bits to a receiver 132. In some embodiments the de-serializer 132 is included within the receiver 131.

Although FIG. 1 shows a single transmitter sending bits to a single receiver, it is common to combine transmit and receive functions in a single device called a transceiver. When both cards use a transceiver the same trace or different traces may be used to provide bidirectional communication between the cards 120 and 130. In the following explanation it is assumed that each “peer” uses a transceiver. Likewise it is presumed that blocks of data are sent from each transmitter 200 continuously to keep the connection occupied. If there is no data to transmit, idle data may be sent.

Although the system 100 is shown with one backplane and two cards other configurations are possible. For instance, systems with multiple backplanes—e.g., two or more—are possible. Likewise, systems with multiple cards—e.g., three or more are possible. Additionally, even though the backplane 110 is shown with eight traces 111A-111H and three connectors 112A-112C other configurations using more (or less) traces than eight, and/or more (or less) connectors than three are possible.

Even though a single Serializer and Deserializer are shown, more than one SerDes connection may use a single trace. Likewise, more than one trace, each with its own SerDes connection may be used. Any suitable configuration of backplanes, traces, connectors, serializers, deserializers and cards are contemplated and included within the scope of the invention.

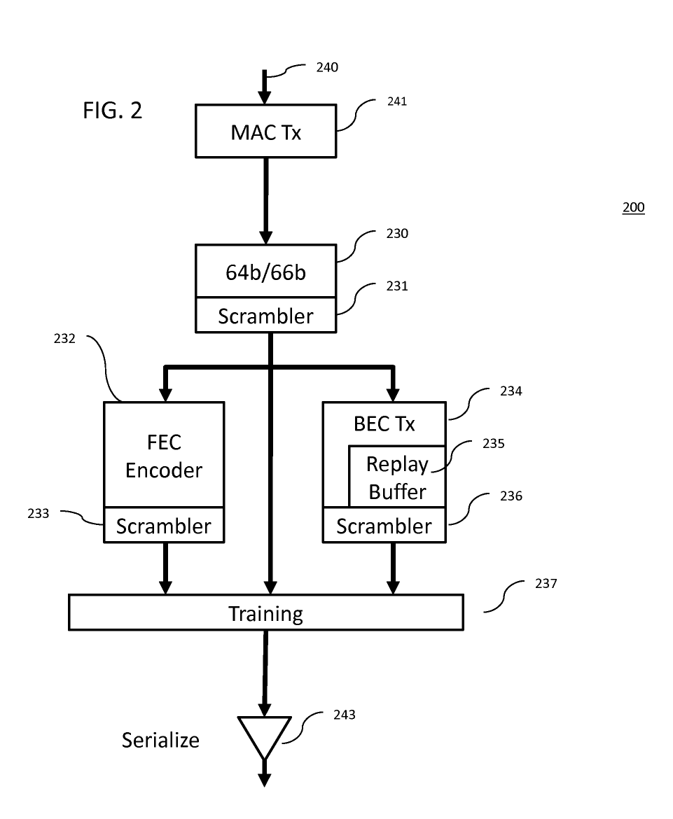

FIG. 2 shows an embodiment of a transmitter 200. The transmitter 200 may receive data via connection 240 which is connected to a MAC Tx 241. The MAC Tx 241 may be a Media Access Control transmitter—i.e., a MAC layer transmitter; connected to the next layer in the network stack. The MAC Tx 241 may produce data which may be processed by a data path containing an encoder.

In an exemplary embodiment of the invention, there is a 64b/66b encoder which may provide data to a scrambler 231. The output of scrambler 231 may provide data for a FEC encoder 232, a Backward Error Correction (BEC) transmitter 234 or connect directly to training unit 237. It should be noted that, in certain embodiments of the invention, training unit 237 may alternatively be considered, and/or may form, part of the Ser-Des connection.

FEC encoder 232 may provide data to scrambler 233 which may provide data to training unit 237. The BEC 234 may utilize replay buffer, 235. The BEC 234 may provide data to scrambler 236 which may provide data to training unit 237.

Preferably the replay buffer 235 is sized to accommodate the amount of data that will be outstanding during a “round trip” transit of the backplane 110. Or the size of the backplane can be limited by the amount of storage reserved for the replay buffer 235.

Likewise, the data rate affects the buffer size/backplane length tradeoff. A faster data rate may require either a shorter backplane 110 or a larger replay buffer 235. Preferably the processing time to Ack or Nak a block of data should be minimized but in all cases must be accommodated as part of the round trip delay of the backplane 110.

Training unit 237 may provide data to serializer 243 which may convert parallel data into a serial bitstream which in turn may drive one or more backplane traces 111A-111H. Training unit 237 may send and receive signals that allow the transmitter and receiver to “train” to the physical environment.

It should be noted that transmitter 200 is typically agnostic to the type and organization of the data received via connection 240. Accordingly, and because error correction according to the invention is preferably substantially implemented in the PHY layer, no effort is made to align the serial bitstream according to data packets and structures that may exist in the data presented to the MAC Tx, a MAC layer or any other network layer.

Training unit 237 may be used to choose one of the data processing paths. Optionally a multiplexor may be used to choose one of the available data processing paths. The choice of data path will depend on the requirements of the SerDes connection. Preferably the path using the BEC based path is chosen when a BER<10⁻²⁰ is required. A SerDes with an FEC may produce an inferior result when compared to the BEC-based path according to the invention.

Although a certain encoder is shown for transmitter 200, any suitable encoder may be used within the scope of the invention.

Although a single encoder is shown for transmitter 200 multiple encoders are a possible configuration for the transmitter. Some encoder outputs may be scrambled, some may be scrambled after encoding and again after error correction and some encoder outputs may not be scrambled. All suitable configurations of encoders and scramblers are possible and included within the scope of the invention.

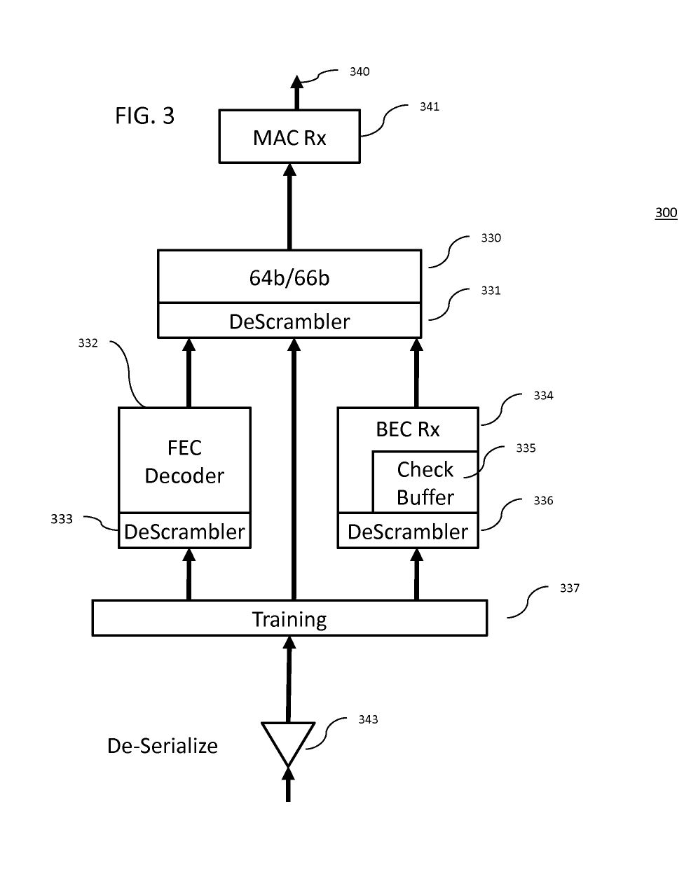

FIG. 3 shows an embodiment of a receiver 300. The receiver 300 may receive data via de-serializer 343 which may receive data from one or more backplane traces. De-serializer 343 may provide data to training unit 337. De-serializer 343 may convert the serial bitstream into parallel data. Training unit 337 is preferably similar in form and function to training unit 237.

Training unit 337 may be used to choose one of the multiple data processing paths. Optionally a de-multiplexor may be used to choose one of the available data processing paths. The choice of data path will depend on the requirements of the SerDes connection. Preferably the path using the BEC based path is chosen when a BER<10⁻²⁰ is required.

The training unit 337 may provide data to a descrambler 333 which may provide data to an FEC decoder 332. The FEC decoder 332 may provide data to a descrambler 331 which in turn may provide data to a 64b/66b decoder 330. It should be noted that, with respect to the systems and methods of the invention, any utilization of a training unit may be considered an optional feature of the invention, and not specifically required for implementation of the invention.

The training unit 337 may provide data to descrambler 336 which may provide data to a BEC receiver 334. The BEC 334 may make use of a check buffer 335. The BEC receiver may provide data to the descrambler 331 which in turn may provide data to the 64b/66b decoder 330. The training unit 337 may provide data directly to descrambler 331. The 64b/66b decoder 330 may provide data to a MAC Rx 341. MAC Rx 341 may provide data via connection 340. The MAC Rx 341 may be a Media Access Control receiver—i.e., a MAC layer receiver—connected to the next layer in the network stack.

The receiver can preferably be agnostic to the type and organization of the data received. Preferably, no effort is made to orient the serial bitstream according to data packets and structures that may exist in the data presented by the MAC Rx.

Although a certain decoder is shown for receiver 300, any suitable decoder may be used within the scope of the invention. Preferably the data path choice and the encoder, of the transmitter 200 will match the data path choice of the receiver 300.

Although one decoder is shown for receiver 300 multiple decoders are a possible configuration for a receiver 300. Some decoder inputs may be descrambled, some may be descrambled prior to error correction and again prior to decoding and some decoder inputs are not descrambled. All suitable configurations of decoders and descramblers are possible and included within the scope of the invention.

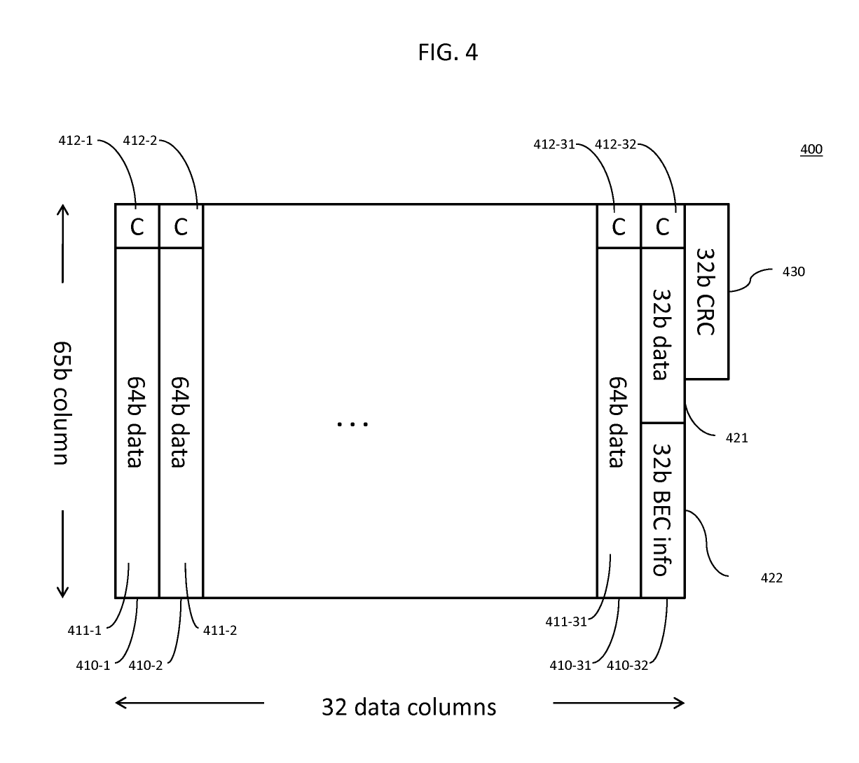

FIG. 4 shows an embodiment of a BEC block 400. The BEC block 400 structure is agnostic to the structure of data presented to the transmitter. One exemplary purpose of the BEC block structure is to provide a structure which enables error correction to be performed thereon.

The control flag 412-1-412-31 are used to indicate whether the column beneath the flag is control information or data only.

Preferably, the BEC block 400 is comprised of 32 data columns labeled 410-1-410-32 and a Cyclic Redundancy Check (CRC) 430. The data columns 410-1-410-31, comprise a data sections 411-1-411-31 and a control flag 412-1-412-31. Preferably, each data section is 64 bits long, but any suitably-sized data section is contemplated and included within the scope of the invention. Other possible configurations including fewer or greater numbers of data columns are contemplated and included within the scope of the invention.

Preferably, the data column 410-32 may be comprised of a short 32 bit data section 421 and a 32 bit BEC info section 422. A short data section is not required nor does the short data section need to be 32 bits in length. Likewise the BEC info section need not be 32 bits nor is it required to share a data column with a data section. All suitable combinations of short data sections, or, alternatively, of any suitable length data sections, and BEC information sections are contemplated and included within the scope of the invention.

The CRC 430 may use any one of a family of known methods of verifying the correctness of the data in a block. Preferably the CRC 430 is 32 bits long but any suitable length is contemplated and included within the scope of the invention. Preferably the CRC method and length is chosen to provide a selected BER rate of <10⁻²⁰ as required by the application despite the environmental BER occurring in SerDes connection.

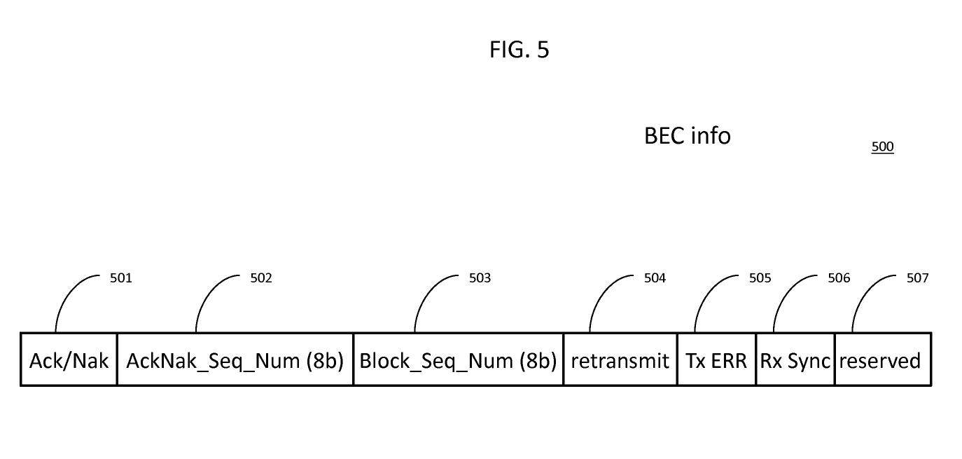

The details of an exemplary BEC info 422 are shown in FIG. 5. The format of the BEC info presumes that each sent BEC block 400 contains both an outgoing set of data from a transmitter 200 and the response to a block of data received a receiver 300. As such, an embodiment of a transceiver is presumed for both ends of the SerDes connection. An Ack/Nak bit 501 is set by the receiver but not by the transmitter 200. The value of the bit setting for Ack as opposed to Nak is arbitrary but may be standardized. Preferably the AckNak_Seq_Num 502 has a length of 8 bits; any size AckNak_Seq_Num is contemplated and included within the scope of the invention. The AckNak_Seq_Num 502 is the acknowledge/negative-acknowledge block sequence number received by the receiver and is either acknowledged as correct (Ack) or negatively acknowledged as incorrect (Nak) according the value of the Ack/Nak bit.

Preferably the Block_Seq_Num 503 Num has a length of 8 bits; any size Block_Seq_Num is contemplated and included within the scope of the invention. The Block_Seq_Num is a block sequence number used to arbitrarily number the blocks sent from the transmitter 200 to the receiver 300 so that blocks that are lost or in error can be identified and retransmitted as explained below. Preferably the length of the AckNak_Seq_Num is the same as the length of the Block_Seq_Num.

The retransmit bit 504 may be set when the block sent is a retransmitted block. The retransmit bit may be set to a transmission state or to a retransmission state. The value of the retransmit bit setting for transmission as opposed to retransmission is arbitrary but may be standardized. The state of the retransmit bit may be used by upper level protocols with reference to the added delay of data reception due to retransmission.

Tx ERR 505 may be used by the transmitter to indicate that the receiver will receive a block with an error, but there is no need to ask for retransmit for this block because the block is invalid. Rx Sync 506 is an indication from the Rx to the Tx that the Rx is prepared to participate in a retransmission process. This is a type of initialization process for retransmission. Both the Tx Err on the Rx Sync are preferably optional features.

A transceiver including at least one transmitter 200 and at least one receiver 300 may execute three algorithms substantially simultaneously; a transmit mode algorithm, a receive algorithm and a replay buffer algorithm. In the alternative, the transceiver executes a re-transmit algorithm, a receive algorithm and a replay buffer algorithm.

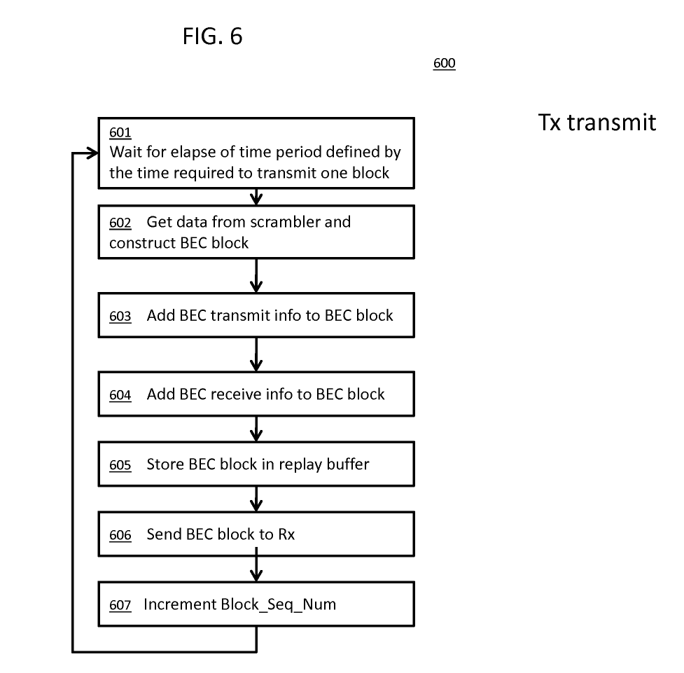

An embodiment of a transmit algorithm 600 is shown in FIG. 6. Prior to the execution of transmit algorithm 600 the Block_Seq_Num is set to zero, a known value or is reset based on a connection failure as described below. The transmit algorithm 600 sends blocks of data or idle data each of which may contain a BEC info 422. The transmit algorithm stores preferably every data block transmitted in the replay buffer 235.

At step 601, progression to the next step 602 occurs at intervals defined by the time required to transmit a block. At step 602 data is received from the scrambler 231 to construct a BEC block 400. At step 603 BEC transmit information is added to the BEC block 400. Transmit information may include a Block_Seq_Num 503 and setting the retransmit bit 504 to the transmission state. At step 604 any available BEC receive information can be added to the BEC block 400. The BEC receive information may include a Ack/Nak bit 501 and a AckNak_Seq_Num relating to a received block.

At step 605 the BEC block 400 is stored in the replay buffer 235. At step 606 the BEC block is sent via the backplane 110 to a receiver 300. At step 607 the Block_Seq_Num is incremented followed by the execution of step 601.

The transmit algorithm may execute preferably endlessly unless the re-transmit algorithm is entered or the SerDes connection fails.

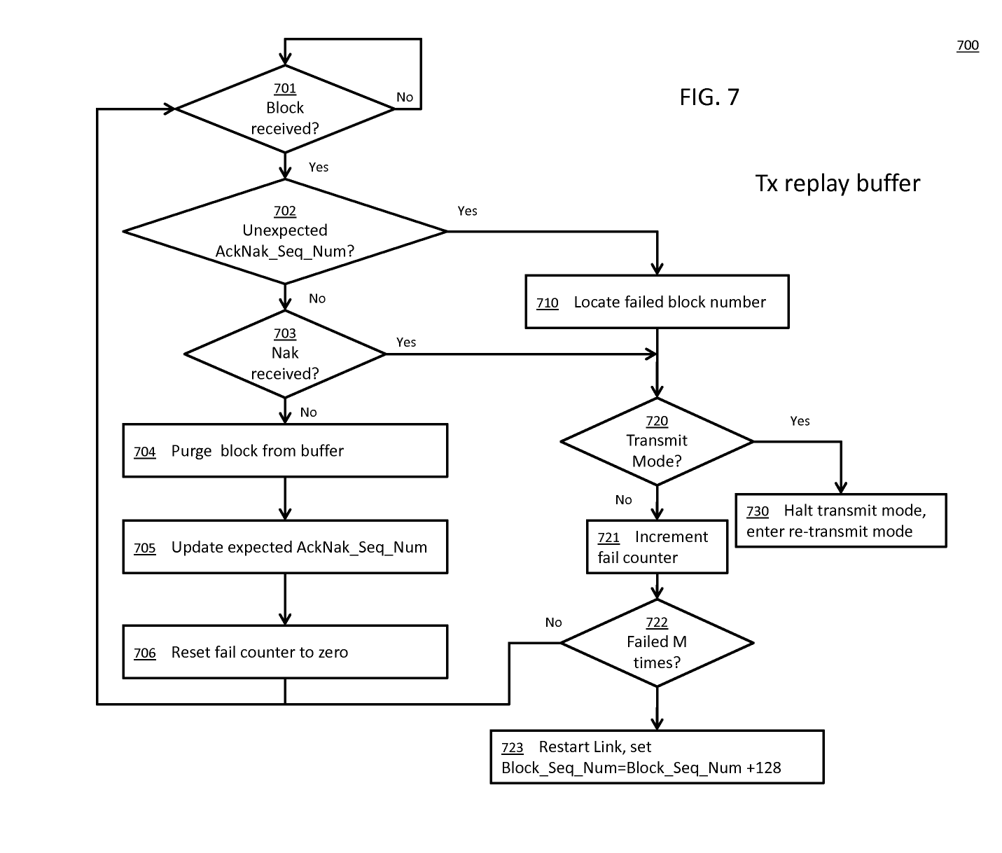

An embodiment of a replay buffer algorithm 700 is shown in FIG. 7. Prior to the execution of replay buffer algorithm 700 a failure counter is set to zero and the expected AckNak_Seq_Num is set in the same manner as the Block_Seq_Num. The response from receiver 300, the response being contained in received BEC info 522, may be analyzed by the transmitter 200 replay buffer algorithm 700. Once reception is confirmed, replay buffer algorithm 700 may remove confirmed blocks from the replay buffer 235.

At step 701 progression to the next step 702 takes place preferably only when a block has been received. Correct reception of the block and therefore the BEC info 422 is confirmed by the receiver 300 via the CRC. At step 702 Ack/Nak bit 501 is checked for an Ack. If there is an Ack, the current saved—i.e., expected-AckNak_Seq_Num is compared to the received AckNak_Seq_Num 502 at step 703. If the expected AckNak_Seq_Num is not different from the received AckNak_Seq_Num 502, then the block numbered AckNak_Seq_Num is purged from the replay buffer 235 at step 704. After the replay buffer is purged at step 704, the expected AckNak_Seq_Num is updated to next sequence number. An exemplary method of updated the saved AckNak_Seq_Num is to increment the saved AckNak_Seq_Num. After the update of the AckNak_Seq_Num at step 705 the failure counter is reset to zero at step 706. After the failure counter is reset to zero at step 706 the replay buffer algorithm resumes waiting for a received packet at step 701.

Returning to steps 701 and 702, if either Ack/Nak bit 501 is a Nak or the expected AckNak_Seq_Num is not equal to the received AckNak_Seq_Num 502, a block has been received with an error at the receiver. At step 710 the replay buffer algorithm checks if re-transmit mode has been entered. If the transmitter 200 is in transmit mode, then at step 720 the transmit algorithm 600 is suspended and the re-transmit algorithm 800 is started to replay the blocks received in error.

If the transmitter 200 is in re-transmit mode, then the replay buffer algorithm checks if the SerDes connection has failed completely. At step 733 the failure counter is incremented. If the fail counter is equal to the M, M being a number set as a suitable parameter—e.g., 3—then the connection is restarted and the Block_Seq_Num may be incremented by 128.

The choice of Block_Seq_Num is preferably chosen to be numerically different from current Block_Seq_Num. For the case of an exemplary unsigned 8-bit number, incrementing the current Block_Seq_Num 128 is preferable. However any suitable choice of resetting the Block_Seq_Num is contemplated and included within the scope of the invention. If the fail counter is not equal to M, then replay buffer algorithm 700 resumes waiting for a received packet at step 701.

It should be noted that the transmit replay buffer algorithm 700 restarts the link after M consecutive failures. Other methods to determine link failure are contemplated and included within the scope of the invention—e.g. a “leaky bucket” paradigm.

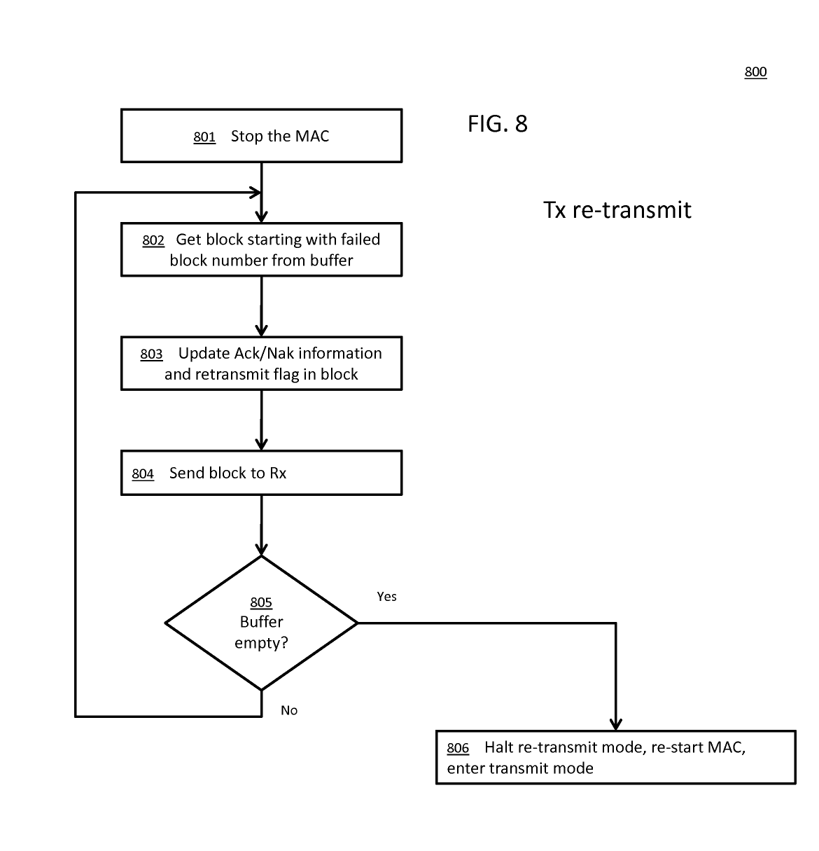

An exemplary embodiment of a re-transmit algorithm 800 is shown in FIG. 8. The re-transmit algorithm 800 may send blocks stored in the replay buffer 235. Re-transmission continues until the replay buffer 235 is empty or the connection is reset by the replay buffer algorithm 700. At step 801 the MAC Tx 241 is halted to prevent loss of data while the replay buffer 235 is emptied. Next, at step 802 a block with received AckNak_Seq_Num is retrieved from the replay buffer 235.

At step 803, the BEC info of the next block to be sent may be updated by setting the retransmit bit 504 to the retransmission state. At step 805 the replay buffer 235 is checked for emptiness. If replay buffer 235 is empty than at step 806, re-transmit algorithm 600 is re-started, the MAC Tx 241 is re-started and the re-transmit algorithm 800 is halted. If the replay buffer 235 is not empty the re-transmit algorithm 800 returns to step 802 to get the next block from replay buffer 235.

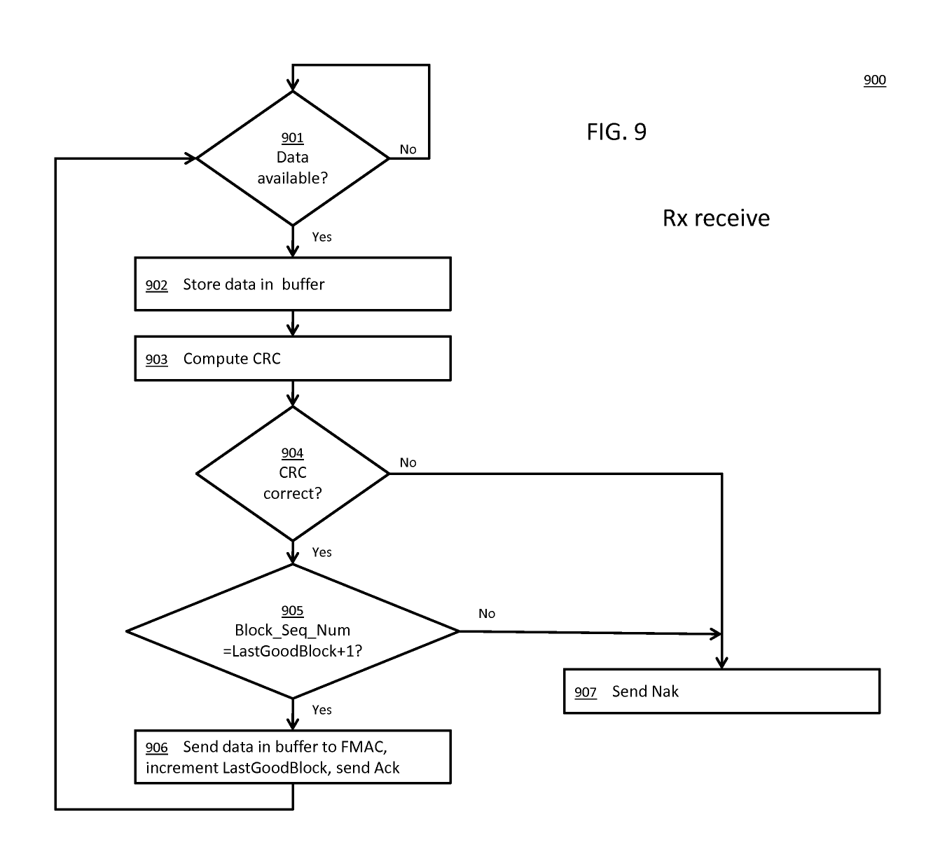

An embodiment of a receive algorithm 900 is shown in FIG. 9. Prior to engaging the receive algorithm 900 the NextGoodBlock is set to correspond to the setting of the Block_Seq_Num. In some embodiments of the invention, the NextGoodBlock is the expected number of the next block to be received. The receive algorithm 900 may receive blocks and confirm correct transmission—i.e., an Ack—, or confirm transmission in error—i.e., a Nak—, for each block.

At step 901 progression to the next step 902 takes place preferably only when data is available to confirm or reject. At step 902 a single block may be stored in a check buffer 335. At step 903 the CRC is computed for the block stored in the check buffer 335. At step 904 the computed CRC is compared to the received CRC 430.

If the CRC is correct, then at step 905 the received Block_Seq_Num is compared to a LastGoodBlock+1—i.e., the expected next block number to be received. If the expected block has been received then the data in the buffer may be sent to the MAC, the LastGoodBlock may be incremented and an Ack is sent. If the data received represents idle data, it will be discarded by the receiver. Sending an Ack means updating the BEC info 422 of an outgoing block by setting the AckNak bit 501 to Ack and setting the AckNak_Seq_Num to the received Block_Seq_Num.

If the computed CRC does not match the received CRC or the Block_Seq_Num is not equal to the LastGoodBlock+1 then the block in the check buffer 335 has been received in error. If a block has been received in error then a Nak is sent and the data is discarded. Sending a Nak means updating the BEC info 422 of an outgoing block by setting the AckNak bit 501 to Nak and setting the AckNak_Seq_Num to the received Block_Seq_Num.

In certain embodiments of the invention, the retransmission protocol may be selectively enabled in response to the connection obtaining a threshold of transmission speed and/or bandwidth. Accordingly, when the connection is operating below a predetermined transmission speed and/or bandwidth, the connection may choose not to enable the retransmission protocol described above, or any other suitable protocol, but when the connection is operating above the predetermined transmission speed and/or bandwidth, the connection may enable the retransmission protocol described above, or other suitable protocol.

In some embodiments of the invention, the retransmission protocol may be triggered by an algorithm that detects a predetermined number of errors per unit time in the connection transmissions. Accordingly, when the connection is operating below a predetermined error rate, the connection may not enable the retransmission protocol described above, or any other suitable protocol, but when the connection is operating above the predetermined error rate, the connection may enable the retransmission protocol described above, or any other suitable protocol.

Thus, methods and apparatus that reduce the error rate of a SerDes connection have been presented. Persons skilled in the art will appreciate that the present invention can be practiced by other than the described embodiments, which are presented for purposes of illustration rather than of limitation, and that the present invention is limited only by the claims that follow.

1. An apparatus for retransmission of blocks over a Serial/De-serial connection, the apparatus comprising:
a transmitter, the transmitter comprising at least one replay buffer; and
a receiver, the transmitter being connected to the receiver via at least one Serial/De-serial connection;
wherein the transmitter is configured to store at least one block of data in the replay buffer and send at least one stored block of'data to the receiver via the Serial/De-Serial connection,
wherein the receiver is configured to notify the transmitter when the at least one stored block is when received correctly,
wherein the receiver is further configured to notify the transmitter when the at least one stored block is not received correctly, and
wherein the transmitter is configured to remove the at least one stored block from the replay buffer when the transmitter is notified that the at least one stored block has been received correctly, and retransmit the at least one stored block when the transmitter is notified that the at least one stored block has not been received correctly.

2. An apparatus for transmitting blocks over a Serial/De-serial connection comprising:
a transmitter having a replay buffer, wherein the transmitter is connected to a Serial/De-serial connection,
wherein the transmitter configured to store at least one block of data in the replay buffer and send the at least one stored block of data to Serial/De-Serial connection,
wherein the transmitter is configured to remove the at least one stored block from the replay buffer when the transmitter has been notified that the at least one stored block has been delivered correctly, and retransmit the at least one stored block when transmitter has been notified that the at least one stored block is has not been delivered correctly.

3. An apparatus for receiving blocks from a Serial/De-serial connection comprising:
at least one receiver,
wherein the receiver is connected to a Serial/De-serial connection receive at least one block of data;
wherein the receiver is configured to transmit an acknowledgment when the at least one block of data is received correctly; and
wherein the receiver is further configured to transmit an a negative acknowledgment when the at least one block of data is not received correctly.

4. The apparatus of claim 3 wherein the receiver comprises at least one check buffer.

5. The apparatus of claim 4 wherein the receiver stores the received block in the check buffer and verifies the stored block.

6. A method for retransmitting blocks over Serial/De-serial connection wherein at least one transmitter is connected to at least one receiver via at least one Serial/De-serial connection, wherein the at least one transmitter comprises at least one replay buffer, the method comprising:
providing a block of data to the transmitter;
storing the block of data in the replay buffer;
sending the stored block of data to the receiver via the at least one Serial/De-Serial connection;
verifying the received block to a receiver;
sending an acknowledgment when the received block is received correctly;
sending a negative acknowledgment when the received block is received incorrectly;
removing the stored block from the replay buffer when the acknowledgment is received; and
retransmitting the stored block when the negative acknowledgment is received.

7. A method for transmitting blocks over Serial/De serial connection from a transmitter is connected to a Serial/De-serial connection, wherein the transmitter comprises a replay buffer, the method comprising:
providing at least one block of data to a transmitter;
storing the at least one block of data in the replay buffer;
sending the at least one stored block of data over the Serial/De-Serial connection;
removing the at least one stored block of data from the replay buffer when the transmitter has been notified that the at least one stored block of data has been delivered correctly; and
retransmitting the s at least one stored block of data when the transmitter has been notified that the at least one stored block of data has not been delivered correctly.

8. The method of claim 18 further comprising, comparing the received acknowledge/negative-acknowledge sequence number with an expected sequence number;
removing the stored block from the replay buffer when the stored block of data has been delivered correctly; and
retransmitting the stored block when the stored block of data has not been delivered correctly.

9. The method of claim 7 further comprising, retransmitting a plurality of stored blocks when the stored block has not been received correctly.

10. The method of claim 7 further comprising,
checking if the same block has failed M consecutive times;
resetting the connection if the same block has failed M consecutive times; and
continuing retransmitting if there have not been M consecutive failures for the same block.

11. The method of claim 7 further comprising,
halting transmission of blocks not in the replay buffer if any block is retransmitted;
checking if the replay buffer is empty; and
resuming transmission of blocks not in the replay buffer if the replay buffer is empty; and
continuing retransmission if the replay buffer is not empty.

12. A method for receiving blocks over a Serial/De-serial connection, the Serial/De-serial connection comprising a transmitter connected to a receiver, the method comprising:
verifying the received block at the receiver;
acknowledging the received block when received correctly; and
negatively acknowledging the received block when received incorrectly.

13. The method of claim 12 wherein the receiver comprises at least one check buffer.

14. The method of claim 13 further comprising, storing the received block in the check buffer wherein verifying the at least one received block comprises verifying the stored block.

15. The method of claim 12 wherein the verifying the received block comprises performing at least one cyclic redundancy check, the verifying further comprising,
computing a cyclic redundancy check on the received block;
comparing the computed cyclic redundancy check with the received block cyclic redundancy check; and
sending a response, wherein the response is an acknowledge if the comparison shows an equality and the response is a negative acknowledge if comparison shows an inequality.

16. The method of claim 12 wherein the verifying the received block comprises verifying at least one block sequence number, the verifying further comprising:
comparing the received block sequence number to a stored last verified block; and
sending a response, wherein the response is an acknowledge if the comparison shows an equality or the response is negative acknowledge if the comparison shows an inequality.

17. The method of claim 16 wherein the acknowledge comprises the received block sequence number.

18. The method of claim 7 wherein an acknowledge, comprising a sequence number, is received when the block of data has been delivered correctly and a negative acknowledge is received, comprising a sequence number, when a block of data has been delivered incorrectly.
